(19) United States
(12) Patent Application Publication
(10) Pub. No.: US 2015/0366399 A1
(43) Pub. Date: Dec. 24, 2015

(54) Cooking Container Lid Having Pyrolysis Function

(71) Applicant: Younghee LEE, (US)

(72) Inventor: Younghee Lee, Jeonju, Jeollabuk-do (KR)

(21) Appl. No.: 14/761,626

(22) PCT Filed: Jan. 27, 2014
(86) PCT No.: PCT/KR2014/000731

§ 371 Date: Jul. 17, 2015

(30) Foreign Application Priority Data
Jan. 28, 2013 (KR) 10-2013-0009024

(51) Int. Cl. A47J 36/06; A47J 36/38

(52) U.S. Cl. CPC A47J 36/06; A47J 36/38

(57) ABSTRACT

The cooking container lid having pyrolysis function comprises a lid body having an opening at the center and adapted to cover the upper part of a cooking container, a junction covering the opening of the lid body and attached to the lid body, a pyrolysis unit located at the bottom side of the junction and adapted to pyrolyze the fumes from cooking as well as to warm the food by radiating its heat towards the cooking container, a convection fan located at the junction and adapted to circulate air around the pyrolysis unit to force the heat effectively transferred to the food, a mesh cover attached to the junction to enclose the pyrolysis unit and the convection fan, an exhaust tube for connecting fluid communication with the pyrolysis unit and adapted to venting the steam and gas from the pyrolysis unit to the outside of the cooking container. The cooking container lid can keep the user safe by removing harmful fumes as soon as they are generated during cooking.

### FIELD OF THE INVENTION

The present invention relates to a pyrolysis device for effectively removing volatile compounds and smells during cooking. Specifically, the present invention relates to a cooking container lid having a pyrolysis device that can remove volatile compounds and smells as they are produced from food heated in cookware.

### DESCRIPTION OF RELATED ARTS

Conventional cookware has no functions to remove volatile compounds and smells generated during cooking. These volatile fumes may contain carcinogenic formaldehyde and a variety of toxic materials. To minimize the adverse effects of using cooking devices, these toxic contaminants should be prevented from spreading into the user's living areas.

Currently in order to remove smoke and smells generated during cooking, the user has to open the windows or operate air purifiers. However, once the contaminants from cooking spread indoors, even after they are completely removed, the user has been already affected by the contaminants.

To solve the above problems, range hoods for discharging fumes are already installed over the range in the kitchen. However, because the range hoods are located far from the place where the cooking is carried out, only a portion of the cooking fumes are discharged outside and the rest of the fumes are diffused into the kitchen. Placing the range hoods close to the range can increase the efficiency for discharging out the fumes, but may also cause an economic cost for re-installing the range hood and violate the local building codes.

A number of different ways for disposing cooking fumes exist, such as an adsorption method using activated carbon filters, a combustion method, a catalytic converter method, an ionic precipitation method, and a plasma discharging method. Among these, the combustion method is highly effective in removing cooking fumes, which are oxidized at high temperature to yield harmless carbon dioxide and water. Also, the combustion method is proven to be economical and reliable enough to be used for the incineration of toxic chemical and biological wastes.

Some cooking ovens have self-cleaning functions to cause pyrolysis at temperatures of about 400-500° C. in order to remove food contaminants accumulated on the wall of the cooking cavity. However, the above case adopts a method of re-heating the cooking cavity after taking out the food and cannot solve the problem of diffusing fumes during cooking. Therefore, a device for effectively removing contaminants generated during cooking is desired.

The present invention provides a cooking container lid having pyrolysis function for effectively removing cooking fumes. An object of the present invention will keep the user safe from the harmful cooking fumes by removing the fumes as soon as they are generated during cooking.

The following patents are known in the art and are incorporated by reference herein: Korean Pat. Nos. 10-0518444; 10-0555420, 10-1203444; and U.S. Pat. Nos. 6,316,749; 6,318,245; 7,878,185; 8,101,894.

### SUMMARY OF THE INVENTION

The cooking container lid having pyrolysis function comprises: a lid body having an opening at the center and adapted to cover the upper part of the cooking container, a junction covering the opening of the lid body and attached to the lid body, a pyrolysis unit located at the bottom side of the junction and adapted to pyrolyze the fumes from cooking as well as to warm the food by radiating its heat towards the cooking container, a convection fan located adjacent to the pyrolysis unit at the bottom side of the junction and adapted to circulate air around the pyrolysis unit to have the radiant heat effectively transferred to the food, a mesh cover attached to the junction to enclose the pyrolysis unit and the convection fan, the mesh cover having a multitude of holes formed to transmit the light and heat from the pyrolysis unit, and an exhaust tube for connecting fluid communication with the pyrolysis unit and adapted to venting the steam in the cooking container and gas from the pyrolysis unit to the outside of the cooking container.

The pyrolysis unit comprises: a heating means connected to a power source for emitting heat therefrom, a pyrolysis tube having a hollow portion formed to enclose the heating means, the pyrolysis tube being heated by the heating means and radiates its heat to the food in the cooking container, and a pyrolysis space formed between the heating means and the pyrolysis tube in which the steam and fumes from food enter to be pyrolyzed.

The cooking container lid covers a circumferential opening of a cooking container to warm the food and keep the food contained within the cooking container. The lid body is made of transparent glass through which the inside of the cooking container can be observed. The lid body has an opening formed at the center, and the outer edge of the lid body has a packing seal made of silicone. The packing seal prevents any leakage of steam and fumes through the gap between the lid body and the opening of the cooking container. The junction, which is attached to the lid body, covers the opening of the lid body and provides an area where the various components for the pyrolysis function are attached.

The heating means is installed at the bottom side of the junction and connected to a power source, The heating means is selected from a group consisting of a halogen heater, a carbon heater, and a resistant wire wound in a coil form. Its energy rating is between 600-1,500 watts (W).

The pyrolysis tube is selected from a group consisting of a heat-resisting metal, a quartz tube or a combination of a heat-resisting metal and a quartz tube. The pyrolysis tube is a hollow round tube-type shape with both ends open. A pyrolysis space is formed between the heating means and the pyrolysis tube where air flow communication is possible. The pyrolysis space is heated by the heating means, and the fumes passing through this space are pyrolyzed.

The exhaust tube is a hollow tube connected to the middle section of the pyrolysis tube and functions as a passage for the clean air exiting the pyrolysis tube towards the outside of the cookware.

The convection fan is located at the bottom of the, unction and along the side of the pyrolysis tube. Because there is a temperature difference over 600° C. between the center of the cookware and the pyrolysis tube, the air is forcibly convected by the convection fan, which rapidly increases the temperature of the cookware.

It is preferable to control the temperature of the cooking container according to the types of food by a temperature sensor installed on the junction to sense the temperature.

The lid body, junction, and other components on the junction are assembled in an airtight manner, so that the steam and fumes in the cooking container are only discharged through the exhaust tube. Therefore, the steam and fumes enter the pyrolysis space through the openings at both ends of the pyrolysis tube, where they are pyrolyzed and discharged outside.

The cooking container lid further includes a flow supply unit located at the top side of the junction. The flow supply unit generates a lower-than-atmospheric pressure both in the exhaust tube and the pyrolysis space and forcibly moves fumes into the pyrolysis tube. The connection of the flow supply unit to the exhaust tube facilitates the discharge of clean air exiting the pyrolysis space.

The flow supply unit includes a blower that has an inlet and an outlet, and serves to create a flow of air. The flow supply unit further comprises a venturi tube to which the exhaust tube is connected at the point where the air path is narrowed. The flow of air becomes faster, which creates a lower-than-the-atmospheric pressure in the exhaust tube and moves fumes into the pyrolysis space.

The mesh cover is made of durable metallic material, is attached to the bottom side of the junction, and encloses the convection fan and other components on the junction to protect them from any external impact.

### BRIEF DESCRIPTION OF THE DRAWINGS

FIG. 1 is a front view showing a cooking container lid 10 where portion of the mesh cover 60 is omitted.

FIG. 2 is a sectional view taken along the line 2-2 of FIG. 1.

FIG. 3 is a perspective view of the pyrolysis unit 40 and the exhaust tube 48.

FIG. 4 is a sectional view showing an exemplary use of the cooking container lid 10 with a cooking container 100.

### DETAILED DESCRIPTION OF THE INVENTION

The objects and features of the present invention will be now made in detail to the preferred embodiment with reference to the attached drawings.

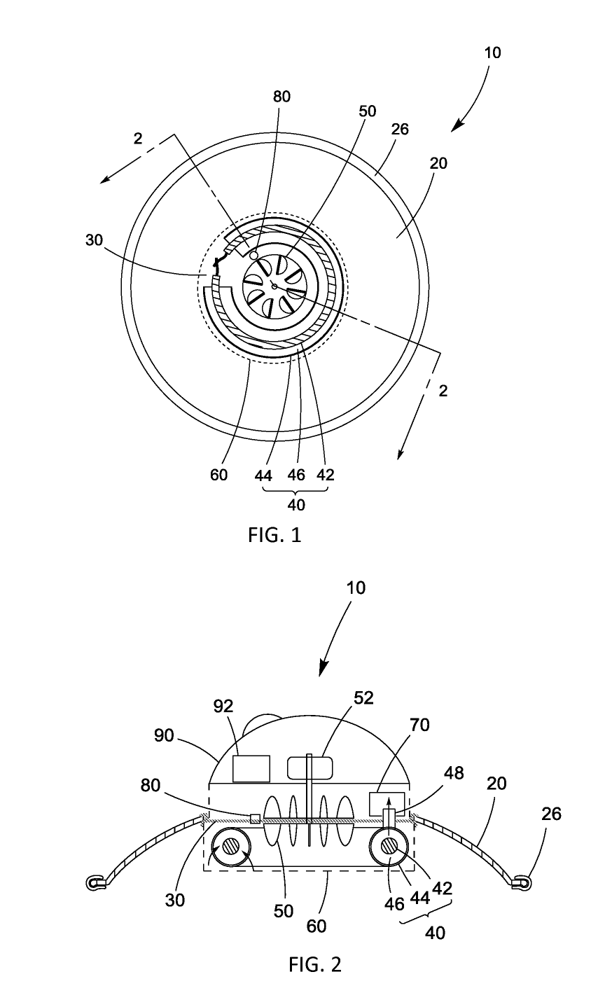

FIG. 1 is a front view showing a cooking container lid 10 where a portion of the mesh cover 60 is omitted and FIG. 2 is a sectional view taken along the line 2-2 of FIG. 1. As shown in FIG. 1 and FIG. 2, the lid body 20 has a round shape, and a round opening is formed at the center. It is desirable that the lid body 20 is made of heat and shatter-resistant transparent glass through which the inside of cooking container 100 (refer to FIG. 4) can be observed and has the shape of a round dome. The outer edge of the lid body 20 is wrapped by a packing seal 26. The packing seal 26 prevents any leakage of steam and fumes in the cooking container 100 through the gap between the lid body 20 and the opening of the cooking container 100. The packing seal 26 is made of silicone which can withstand the typical range of cooking temperature between 60-250° C.

The junction 30 is a round shaped-plate which is fixedly attached to the lid body 20 in an airtight manner covering the opening formed at the center and provides a space where various components for the cooking container lid 10 are attached.

The pyrolysis unit 40 is installed at the bottom side of junction 30 and pyrolyzes the fumes from cooking as well as warms the food by radiating its heat towards the cooking container 100. The pyrolysis unit 40 comprises a heating means 42, a pyrolysis tube 44, and a pyrolysis space 46.

The heating means 42 is connected to a power source, emits heat for cooking, and is selected from a group consisting of a halogen heater, a carbon heater, or a resistant wire wound in a coil form. The heating means 42 is formed in a round shape as shown in FIG. 1, but can be formed in a straight shape or other shapes.

The pyrolysis tube 44 has a hollow round tube-type shape with both ends open and encloses the heating means 42. The pyrolysis tube 44 can have not only a round shape similar to the heating means 42 but also a variety of other shapes. The pyrolysis tube 44 is heated by the heating means 42 and radiates its heat towards the center of the cooking container 100 to warm the food. The pyrolysis tube 44 is selected from a group consisting of a heat-resisting metal, a quartz tube, and a combination of a heat-resisting metal and a quartz tube.

A pyrolysis space 46 is formed between the heating means 42 and the pyrolysis tube 44 where air flow communication is possible. The pyrolysis space 46 is heated by the heating means 42 and the fumes passing through this space are pyrolyzed. Typically, the surface temperature of the heating means 42 is in the 600-800° C. ranges and the surface temperature rapidly decreases as the heating means 42 radiates heat to the surroundings. However, the heating means 42 according to the present invention is enclosed by the pyrolysis tube 44, which prevents a rapid decrease in its temperature. Eventually, a high enough temperature is maintained in the pyrolysis space 46 where the fumes are drawn into and pyrolyzed.

A temperature sensor 80 is installed on the junction 30 to control the cooking container 100 temperature. The temperature sensor detects the temperature and communicates to the control unit 92 to maintain the preset temperature or a variety of temperature ranges depending on the types of cooking.

It is preferable that the power consumption of the heating means 42 is between 600-1,500 watts (W). If the power consumption of the heating means 42 is over 1,500 watts, both the pyrolysis efficiency and cooking speed increase, but the cooking container 100 and the cooking container lid 10 are unnecessarily stressed, and thus the energy efficiency and product safety may decrease. If the power consumption of the heating means 42 is less than 600 watts, the pyrolysis efficiency and cooking speed may decrease.

The exhaust tube 48 is a hollow tube connected to the middle section of the pyrolysis tube 44, preferably at the equal distance from each end. The exhaust tube 48 passes through the junction 20 at a right angle and functions as a passage for clean air exiting the pyrolysis tube 44 to the outside of cooking container 100.

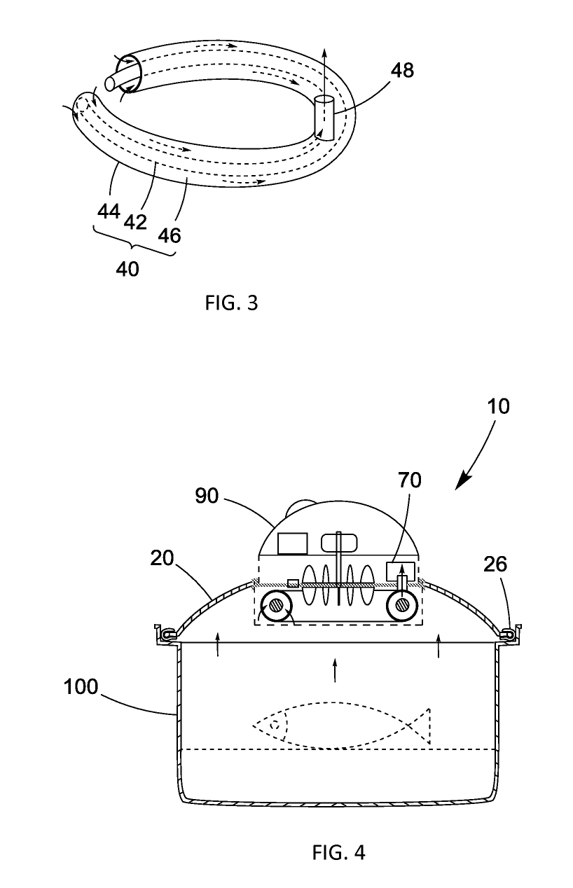

As illustrated in FIG. 3, the fumes in the cooking container 100 are drawn into the pyrolysis space 46 through both ends of the pyrolysis tube 44. The fumes pass through the pyrolysis space 46, are pyrolyzed, and are discharged as clean air outside through the exhaust tube 48.

The convection fan 50 is located at the bottom of the junction 30 and along the side of the pyrolysis tube 44 for circulating air in the cooking container 100. Because there is a temperature difference over 600° C. between the center of the cooking container 100 and the pyrolysis tube 44, the air is forcibly convected by the convection fan 50, rapidly increasing the temperature of the cooking container 100. The convection fan 50 is connected to a motor 52 via a rotating axle which passes through the junction 30 at a right angle and rotates its blades to circulate the air in the cooking container 100.

A mesh cover 60 having a multitude of holes is also installed on the bottom side of the junction 30 to enclose the pyrolysis unit 40 and the convection fan 50 to protect them from any external impact. The holes are formed to effectively transmit the light or radiant heat of the pyrolysis unit 40 towards the food in the cooking container 100. It is desirable that the mesh cover 60 is made of durable metallic material.

A lid housing 90 is fixedly attached to the upper side of the junction 30. A handle, at least one control means for controlling the working temperature and time of the cooking container lid 10, a motor 52 connected to the convection fan 50, a control unit 92, and a flow supply unit 70 are all installed in the lid housing 90.

A flow supply unit 70 connected to the exhaust tube 48 for facilitating the discharge of the clean air from the pyrolysis space 46 is located inside of the lid housing 90. The flow supply unit 70 includes a blower (now shown) that has an inlet and an outlet and serves to create a flow of air. The blower forms a vacuum state at the inlet (not shown) and generates an air flow at the outlet (not shown) by forming a pressure differential while its blades rotate. Upon connection of the exhaust tube 48 to the inlet of the blower, a lower-than-atmospheric pressure is formed in the exhaust tube 48 and pyrolysis space 46, which causes the fumes in the cooking container 100 to enter the pyrolysis space 46. Eventually, a lower-than-atmospheric pressure is also formed in the cooking container 100. Therefore, the steam and fumes do not leak out of the cooking container 100, are pyrolyzed in the pyrolysis tube 44, pass through the exhaust tube 48 to enter the blower, and are discharged outside.

The flow supply unit 70 can include a venturi tube (not shown) which is connected between the exhaust tube 48 and the outlet of the blower. The venturi tube has a structure in which its air path becomes narrow at the middle section and becomes wide again. Because the exhaust tube 48 is connected to the middle section of the venturi tube and the blower outlet is connected to the inlet of the venturi tube, the flow of air becomes faster at the middle section of the venturi tube. Then a lower-than-atmospheric pressure is formed in the exhaust tube 48, which draws fumes in the cooking container 100 into the pyrolysis space 46.

The control unit 92 is connected to the power source, the control means (not shown), the temperature sensor 80, the motor 52, and the pyrolysis unit 40 in order to adjust the preset temperature of the cooking container 100 and time when the cooking container lid 10 is used for cooking.

FIG. 4 is a sectional view showing a preferred use of the cooking container lid 10 with cooking container 100. The lid body 20, junction 30, and other components on the junction 30 are assembled in an airtight manner. The packing seal 26 on the outer edge of the lid body 20 also provides an airtight seal at the gap between the lid body 20 and the upper portion of the cooking container 100. The steam and fumes do not leak out of the cooking container 100, are drawn into the pyrolysis space 46 through the openings at both ends of the pyrolysis tube 44 and pyrolyzed in the pyrolysis tube 44, then pass through the exhaust tube 48 to be discharged outside. As described above, it is possible that the flow supply unit 70 connected to the exhaust tube 48 facilitates the discharge of air to outside of the cooking container 100. Even if there is no flow supply unit 70 installed on the cooking container lid 10, the steam and fumes do not leak out of the cooking container 100 and are drawn into the pyrolysis space 46 to be pyrolyzed and discharged outside through the exhaust tube 48.

While the present invention has been particularly shown and described with reference to exemplary embodiments thereof, it will be understood by those of ordinary skill in the art that various changes in form and details may be made therein without departing from the spirit and scope of the present invention as defined by the following claims.

LIST OF NUMERALS

| | |
|---|---|
| 10: Cooking container lid | 20: Lid body |
| 26: Packing seal | 30: Junction |
| 40: Pyrolysis unit | 42: Heating means |
| 44: Pyrolysis tube | 46: Pyrolysis space |
| 48: Exhaust tube | 50: Convection fan |
| 52: Motor | 60: Mesh cover |
| 70: Flow supply unit | 80: Temperature sensor |
| 90: Lid housing | 92: Control unit |
| 100: Cooking container | |

What is claimed is:

1. A cooking container lid comprising:
a lid body having an opening at the center and adapted to cover the upper part of cooking container;
a junction covering the opening of the lid body and attached to the lid body;
a pyrolysis unit located at the bottom side of the junction and adapted to pyrolyze the fumes from cooking as well as to warm the food by radiating its heat towards the cooking container;
a convection fan located at the bottom side of the junction and adapted to circulate air around the pyrolysis unit to have the radiant heat effectively transferred to the food;
a mesh cover attached to the junction to enclose the pyrolysis unit and the convection fan, the meshed cover having a multitude of holes formed for transmitting the light and heat from the pyrolysis unit;
an exhaust tube for connecting fluid communication with the pyrolysis unit and adapted to venting the steam in the cookware and gas from the pyrolysis unit to the outside of the cooking container; and
a flow supply unit connected to the exhaust tube for venting out the clean air by generating a lower-than-atmospheric pressure which draws fumes into the exhaust tube and the pyrolysis space, the flow supply unit comprising a blower that has an inlet and an outlet and serves to create a flow of air;
wherein the pyrolysis unit comprising:
a heating means for emitting heat therefrom;
a pyrolysis tube having a hollow portion formed to enclose the heating means, the pyrolysis tube being heated by the heating means and radiating its heat to the food; and
a pyrolysis space formed between the heating means and the pyrolysis tube in which the steam and fumes from food enter to be pyrolyzed.

2. The cooking container lid of claim 1, further comprising a packing seal which wraps the outer edge of the lid body for preventing any leakage of steam and fumes in the cooking container through the gap between the lid body and the opening of the cooking container.

3. The cooking container lid of claim 1, wherein the lid body is made of glass through which the inside of cooking container can be observed.

4. The cooking container lid of claim 1, further comprising a temperature sensor for sensing the temperature of the cooking container.

5. The cooking container lid of claim 1, wherein the heating means is selected from a group consisting of a halogen heater, a carbon heater, and a resistant wire wound in a coil form.

6. The cooking container lid of claim 1, wherein the power consumption of the heating means is between 600-1,500 watts (W).

7. The cooking container lid of claim 1, wherein the pyrolysis tube is selected from a group consisting of a heat-resisting metal, a quartz tube, and a combination of a heat-resisting metal and a quartz tube.

8. The cooking container lid of claim 1, wherein the pyrolysis tube has a hollow tube-type shape with both ends open.

9. The cooking container lid of claim 1, wherein the exhaust tube is connected to the middle section of the pyrolysis tube.

10. The cooking container lid of claim 2, wherein the packing seal is made of silicone.

11. The cooking container lid of claim 1, wherein the flow supply unit further comprises a venturi tube which is connected to the outlet of the blower and the exhaust tube, the exhaust tube being connected to the middle section of the venturi tube where the air path is narrowed and the flow of air becomes faster, which creates a lower-than-atmospheric pressure in the exhaust tube and draws fumes into the pyrolysis space.
